(19) United States
(12) Patent Application Publication
(10) Pub. No.: US 2005/0009467 A1
(43) Pub. Date: Jan. 13, 2005

(54) System and method for satellite communication with a hybrid payload and DAMA support

(76) Inventor: Raymond Mark Nuber, Rancho Palos Verde, CA (US)

Correspondence Address: POSZ & BETHARDS, PLC, 11250 ROGER BACON DRIVE, SUITE 10, RESTON, VA, 20190, US

(21) Appl. No.: 10/618,296

(22) Filed: Jul. 11, 2003

(51) Int. Cl. H04B 7/185

(52) U.S. Cl. 455/12.1

(57) ABSTRACT

Certain embodiments of the present invention provide a system and method for satellite communication with a hybrid payload. Certain embodiments of the present invention provide a data communication satellite with a hybrid (transponding and processing) payload. The satellite includes a hybrid communication payload providing signal transmission and minimal processing of the signal, an antenna for at least one of transmitting and receiving the signal, and a processor for intercepting a communication request. The processor generates a response to the communication request. The communication request may be generated by a user terminal. The processor may assign the communication request to a communication channel based on criteria. The criteria include available bandwidth and/or number of connection requests, for example. In an embodiment, the payload provides minimal processing of the signal. The payload may facilitate communication between a user terminal and a content provider or ground processing controller.

### BACKGROUND OF THE INVENTION

The present invention generally relates to data transmission using a satellite network. In particular, the present invention relates to expediting communication requests in a satellite network using a hybrid payload architecture.

Satellite networks are increasingly used for data communication in a variety of applications. For example, satellite networks may be used to transmit audio/video data from an uplink antenna to a user antenna and set top box for television program viewing. Satellite networks may also be used to transmit data packets for Internet and web access, for example. Additionally, satellite networks are used for cellular phone communication.

A satellite may be one of several types, including a bent pipe or processing satellite, for example. A processing satellite includes processing capability on the satellite. The processing satellite demodulates and processes a carrier signal before retransmitting the signal to a target. A bent pipe satellite receives and relays a transmission carrier signal. For example, the bent pipe satellite receives an uplink signal, amplifies the signal, translates the signal frequency, and retransmits the signal on a downlink. Thus, the bent pipe satellite serves as a data relay. Data signal characteristics may be not be affected by satellite characteristics in a bent pipe satellite. Processing satellites involve increased complexity and increased expense compared to bent pipe satellites. Satellites may be placed in geosynchronous orbit, low Earth orbit, medium Earth orbit, or high Earth orbit. Communications satellites in geosynchronous orbit around the earth are typically bent pipe satellites.

A satellite communication network may be organized in a seven layer protocol model, for example. The seven layers may include a physical layer, a data link layer, a network layer, a transport layer, a session layer, a presentation layer, and an application layer. The model may also include sublayers between layers. For example, a Media Access Control (MAC) sublayer may be placed between the physical and data link layers.

Within a satellite communication network, an important design consideration is how to share communications resources (e.g. broadcast communication channels) of the network among users. A scheme that may be employed is a MAC algorithm. Satellite MAC algorithms may be classified by type of message access, such as fixed assignment, contention, or reservation. Fixed assignment schemes such as Time Division Multiple Access (TDMA) allocate a portion of each channel in time to each user. Contention schemes allow users to access channels on demand using collision resolution methods when user transmissions conflict. Reservation schemes employ short reservation messages in contention mode to allocate user communications resources using a conflict-free scheduling scheme. An example of a reservation method is Demand Assigned Multiple Access (DAMA). Most DAMA methods perform a fundamental set of functions for the MAC sublayer. For example, DAMA methods implement some access controls, allocate signaling communication resources (bandwidth and channels, for example), allocate user data/traffic communication resources (bandwidth and channels, for example), implement network policy, and/or police network usage.

For many high volume data applications, such as television and Internet usage, transfer speed is an important concern. Current satellite data communication systems suffer from delays in transmission from a source to a destination over a satellite relay. Current satellite systems also incur a high rate of retransmission due to errors or “collisions” in sharing satellite resources among multiple users.

Access arbitration schemes have been imported from Ethernet and cable systems to satellite networks to help multiple users share available transmission bandwidth. Transmission resources may be allocated based on TDMA, DAMA, Frequency Division Multiple Access (FDMA), Code Division Multiple Access (CDMA), or a hybrid access scheme, for example. However, current satellite systems still suffer from transmission delay, regardless of an access scheme in use. Thus, a method of improving a transmission access scheme and reducing an effect of delay on data transmission in a satellite network would be highly desirable.

Burst communications, such as TCP/IP data packet communications, often result in inefficient use of satellite transmission bandwidth because a steady stream of data is not sent from a server to a user terminal. Multiple users may face a delay in accessing satellite resources for transmission. Thus, a more effective sharing of satellite transmission bandwidth among multiple users would be highly desirable.

Additionally, relocating extensive processing power on a satellite, rather than a ground station, may be impractical and expensive. Reducing delay in transmissions among the ground station, satellite, and user terminal may also be problematic due to technological and economic limitations. Thus, there is a need for a method for improving satellite system response without an excessive increase in complexity or equipment. Therefore, there is a need for an improved satellite communication system with a hybrid payload.

### BRIEF SUMMARY OF THE INVENTION

Certain embodiments of the present invention provide a system and method for satellite communication with a hybrid payload. Certain embodiments provide an improved satellite communication system. The system includes a user terminal transmitting a request for communication with a content provider, a content provider providing data and/or service, and a satellite for relaying transmissions between the user terminal and the content provider. The satellite intercepts the request from the user terminal and communicates a status to the user terminal.

The data provided by the content provider may include computer-related data, such as TCP/IP packet data, Internet data, and other electronic data, for example. Services provided by the content provider or ground processing controller include cellular phone service and audiovisual multicasting service. The satellite may be a hybrid payload satellite. The satellite may use a demand assigned multiple access resource arbitration protocol to allocate communication resources. The satellite may include an acknowledgement processor for intercepting a connection request from the user terminal. The acknowledgement processor may assign the user terminal to a communication channel based on criteria, such as available bandwidth and number of connection requests. The system may also include a plurality of user terminals. The plurality of user terminals may arbitrate collisions of communication requests from user terminals. Alternatively, the acknowledgement processor may arbitrate collisions of communication requests.

Certain embodiments provide a method for facilitating data transmission in a satellite network. The method includes transmitting a communication request for communicating with a content provider, intercepting the communication request at a satellite, and returning a status message in response to the communication request. The status message may include an acknowledgement or denial message. The status message may also include satellite and/or content provider status.

The method may further include transmitting data to the satellite for relay to the content provider. The method may also include transmitting a response to the satellite for relay to a user terminal. Additionally, the method may include arbitrating a collision between multiple communication requests. The method may further include assigning the communication request to a communication channel based on a criterion. The criterion may include available bandwidth and/or number of connection requests.

Certain embodiments of the present invention provide a data communication satellite with a hybrid payload. The satellite includes a hybrid communication payload providing signal transmission and minimal processing of the signal, an antenna for transmitting and/or receiving the signal, and a processor for intercepting a communication request. The processor generates a response to the communication request. The communication request may be generated by a user terminal. The processor may assign the communication request to a communication channel based on criteria. The criteria include available bandwidth and/or number of connection requests, for example. In an embodiment, the payload provides minimal processing of the signal. The payload may facilitate communication between a user terminal and a content provider or ground processing controller. The payload may use a demand assigned multiple access (DAMA) resource arbitration protocol.

### BRIEF DESCRIPTION OF SEVERAL VIEWS OF THE DRAWINGS

FIG. 1 illustrates a system for satellite communications used in accordance with an embodiment of the present invention.

FIG. 2 illustrates a hybrid payload satellite with DAMA support used in accordance with an embodiment of the present invention.

FIG. 3 illustrates a flow diagram for a method for improved satellite data transmission used in accordance with a preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

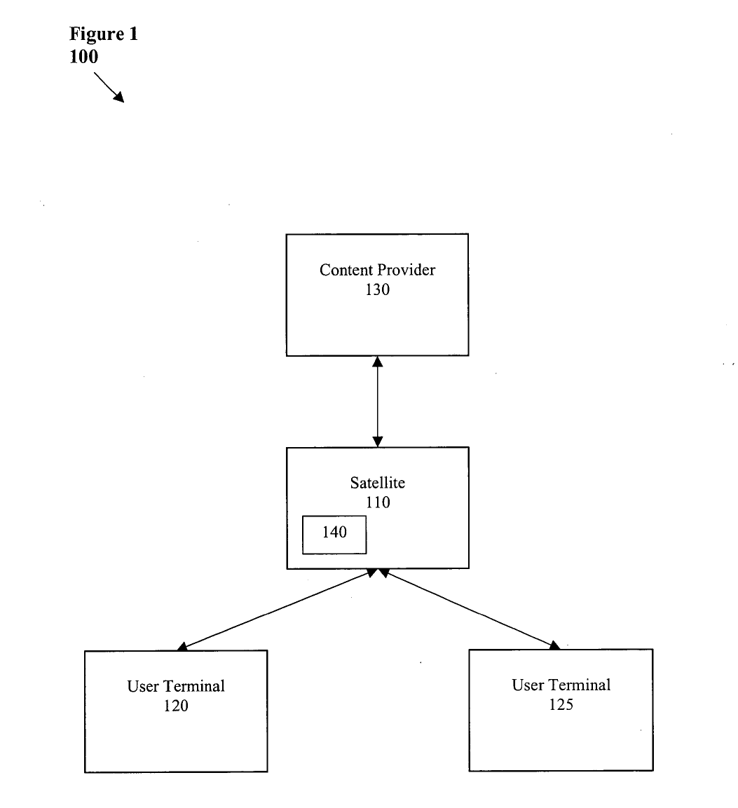

FIG. 1 illustrates a system 100 for satellite communications used in accordance with an embodiment of the present invention. The satellite system 100 includes a satellite 110, user terminals 120, 125, and a content provider 130. In an embodiment, the system 100 includes a plurality of satellites 110, user terminals 120, 125, and content providers 130. The satellite 110 is used to transmit data between the user terminals 120, 125 and the content provider 130.

In an embodiment, the satellite 110 is communications satellite. For example, the satellite 110 may be a bent pipe satellite in a geosynchronous earth orbit. The content provider 130 may be a data server, an audiovisual transmitter, a cellular phone tower, or other ground processing controller, for example. The user terminal 120, 125 may be a personal computer, workstation, satellite dish, or cellular phone, for example. The user terminal 120, 125 and the content provider 130 communicate via the satellite 110. The satellite 110 relays transmissions between the user terminal 120, 125 and the content provider 130. In an embodiment, transmissions from the user terminal 120, 125 may be relayed to the content provider 130 by the satellite 110 and subsequently transmitted from the content provider 130 to another satellite for retransmission to another ground-based terminal. Additionally, multiple user terminals 120, 125 may communicate with one or more satellites 110 for relay to one or more content providers 130. The content provider 130 may provider data and/or services to the user terminals 120, 125. The data provided by the content provider 130 may include computer-related data, such as TCP/IP packet data, Internet data, and other electronic data, for example. Services provided by the content provider 130 or ground processing controller include cellular phone service and audiovisual multicasting service.

In operation, for example, the user terminal 120 requests a web page from the content provider 130. The request is first transmitted to the satellite 110. The satellite 110 then transmits the request to the content provider 130 using available transmission bandwidth. An arbitration scheme may be used to determine access to transmission bandwidth in the satellite network 100.

One arbitration or resource allocation scheme is referred to as Demand Assigned Multiple Access (DAMA). A DAMA system typically allows a connection between any two nodes in a satellite network. DAMA allows multiple users to share transmission resources.

Under a DAMA protocol, communications bandwidth is assigned for a user data transmission based on demand. For example, when a user requests a web page using a web browser or activates a cellular phone to place a call, transmission bandwidth is allocated for the user's demand. A DAMA arbitrator may verify the authenticity of the request. Then, the DAMA system may establish a channel for the user to retrieve the web page or make a phone call, for example. The connection exists while in use and is released back into a “pool” of resources after a user's transaction is complete. Thus, DAMA allows the satellite system 100 to support a plurality of user terminals 120, 125. DAMA uses minimal satellite 110 resources for overhead and for monitoring and provides services to a variety of users.

Several access control methods may be used to implement a DAMA scheme. One method is a multiple access method, such as a Carrier-Sense Multiple Access with Collision Detect (CSMA/CD) method. CSMA/CD allows allocation of transmission resources based on demand. If two user terminals 120, 125 request a transmission channel from the satellite 110 at approximately the same time, however, a collision occurs for the channel. CSMA/CD facilitates detection of an approximately simultaneous access request. If two requesting users request transmission resource access at approximately the same time, the user terminals 120, 125 detect noise indicating a collision. When user terminals 120, 125 or, alternatively, the satellite 110, detect a collision, the terminals 120, 125 stop transmitting. Alternatively, user terminals 120, 125 may broadcast collision signals to notify other user terminals 120, 125 that a transmission failed due to a collision. Each terminal 120, 125 pauses for a random time interval before attempting to retransmit. The random time interval reduces a chance of a subsequent collision between the terminals 120, 125.

For example, the user terminal 120 may transmit data to the content provider 130 via the satellite 110 utilizing a CSMA/CD access protocol. First, the user terminal 120 locates the satellite 110 for transmission (also known as carrier sensing). Then, the user terminal 120 determines whether transmission bandwidth is available. If sufficient bandwidth is available, the user terminal 120 begins data transmission. The user terminal 120 monitors the satellite 110 transmission bandwidth for a collision during transmission. If a collision is detected, the user terminal 120 ceases data transmission. The user terminal 120 transmits a collision or “jam” sequence. The length of the collision sequence may indicate the length of the collision. After transmitting the collision sequence, the user terminal 120 waits for a random time interval before reinitiating data transmission. If another collision occurs, the random time interval is adjusted. The user terminal 120 repeats transmission attempts until data transmission is successful. Alternatively, an error may be generated at the user terminal 120 if more than a selected number of collisions occur before the data is transmitted. In one embodiment, the user terminal 120 may either receive or transmit data during a satellite access. In another embodiment, the user terminal 120 may receive and/or transmit data during a satellite access.

In an embodiment, the user terminal 120 is a personal computer connected to a satellite dish. The content provider 130 is a web server with an antenna. The satellite 110 is a communications satellite relaying data between the server and the computer. Data travels from the server to the computer in approximately ¼ second, for example. Additionally, after a certain amount of data has been transmitted, an acknowledgement of receipt is sent to continue the data transmission. If a large amount of data is being transmitted with a high desired speed, transmission delay and latency incurred while waiting for transmission acknowledgements may be noticeable at the user terminal 120. For example, if a personal computer is receiving web page or other Internet data from a web server, speed and efficiency are highly desirable. The satellite 110 may assist in improving speed and responsiveness of data transfers.

In a conventional satellite, a bandwidth or connection request would be transmitted to the content provider 130. The user terminal 120, 125 would then wait for an acknowledgement from the content provider 130 to begin transmission. Transmission requests travel from the user terminal 120, 125 to the satellite 110. Then the request is relayed from the satellite 110 to the content provider 130. Then the acknowledgement is transmitted back to the satellite 110, which relays the acknowledgement to the user terminal 120, 125.

In an embodiment, an acknowledgement processor 140 is incorporated into the satellite 110. The acknowledgement processor 140 assists in execution of the DAMA and/or CSMA/CD protocol. The acknowledgement processor 140 or resource controller on the satellite 110 intercepts a bandwidth/connection request from the user terminal 120, 125. The acknowledgement processor 140 notifies the user terminal 120, 125 of available resources for transmission to the content provider 130 via the satellite 110.

Including the acknowledgement processor 140 on the satellite 110 decreases communication latency because a resource controller is on the satellite 110 rather than at the content provider 130. The acknowledgement processor 140 assigns user terminals 120, 125 to communication channels based on criteria, such as available bandwidth and/or number of connection requests, for example. An acknowledgement of the requests by the processor 140 eliminates the latency incurred for transmission between the satellite 110 and the content provider 130. The processor 140 may add minimally to the complexity of the satellite 110. An acknowledgement or denial by the processor 140 allows the user terminal 120, 125 to proceed with transmission, retransmission, or alternate routing without undue delay.

The processor 140 may communicate status of the content provider 130 and/or the satellite 110 to the user terminal 120, 125. The processor 140 may control an allocated number of connections or slots for the satellite 110. The processor 140 may determine which user terminals 120, 125 may use the connections with the satellite 110.

For example, a transmission from the user terminal 120 to the content provider 130 via the satellite 110 may take ¼ second. Thus, transmitting a message from the user terminal 120 and the content provider 130 is ¼ second, and transmitting a message back to the user terminal 120 from the content provider 130 is ¼ second, for a total of a ½ second round trip. Accommodating transmission requests at the satellite 110 using the acknowledgement processor 140 reduces the transmission time to ¼ seconds, rather than ½ second.

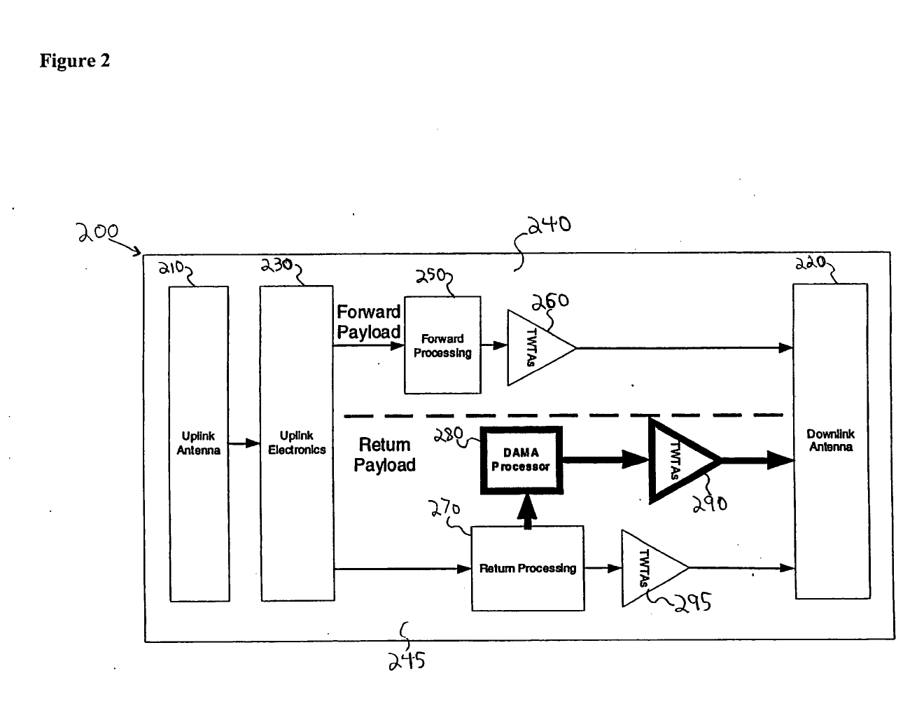

FIG. 2 illustrates a hybrid payload satellite 200 with DAMA support used in accordance with an embodiment of the present invention. The satellite 200 is similar to the satellite 110 in the satellite communications system 100, described above in relation to FIG. 1. The satellite 200 includes an uplink antenna 210, a downlink antenna 220, an uplink electronics 230, a forward payload section 240, and a return payload section 245. The forward payload section 240 includes a forward processing module 250 and a forward traveling wave tube amplifier (TWTA) 260. The return payload section 245 includes a return processing module 270, a DAMA processor 280, and return TWTAs 290, 295.

The satellite 200 provides both “forward” and “return” signal processing using the forward payload section 240 with the forward processing module 250 and the return payload section 245 with the return processing module 270. The TWTAs 260, 290, 295 help amplify uplink and downlink signals. Signal processing includes low noise amplification, frequency conversion, high power amplification, channelization/filtering, gain control, uplink-to-downlink beam connectivity configurability, and/or other processing tasks, for example. In an embodiment, the satellite 200 has a minimal processing payload (a hybrid payload), rather than being a processing satellite. In an embodiment, processing in the satellite 200 is a hybrid of a digital payload and an analog or bent pipe payload. Forward processing may be analog bent pipe processing, for example. Analog bent pipe processing may be more efficient in payload size, weight, and/or power. Return processing may be digital, taking advantage of on-board digital processing to handle bursty uplink return traffic, for example (such as TCP/IP packet traffic). The hybrid payload of the satellite 200 includes a capability to intercept bandwidth/connection requests from the user terminals 120, 125. The DAMA processor 280 may be used to intercept and process bandwidth/connection requests.

The DAMA processor 280 transmits a message granting or denying access to satellite 200 transmission resources to the user terminal 120, 125. In an embodiment, the DAMA processor 280 does not acknowledge collisions between connection requests. User terminals 120, 125 that collide in data transmission may detect a collision and initiate “backoff” procedures more quickly without having to wait for the content provider 130 to issue a collision detection message.

In an embodiment, the DAMA processor 280 includes pseudonoise (PN) sequence correlators that distinguish a signal from noise in satellite DAMA channels. PN sequences are binary sequences that are periodic but exhibit random noise-like properties. A multichannel demodulator with the DAMA processor 280 recovers and decodes DAMA request messages. The mutichannel demodulator of the DAMA processor 280 generates DAMA replies and multiplexes the replies into satellite downlink signals. Alternatively, the DAMA processor 280 may generate a special downlink signal for the user terminal 120, 125 that is not multiplexed with other downlink signals.

Thus, certain embodiments provide a communications payload for the satellite 200 that performs a minimal subset of DAMA functions. The minimal subset may be based on features and performance of a selected satellite communications network. For satellites in geosynchronous orbit, for example, time delay in signals traversing the distance between the satellite 200 and the content provider 130 impacts network performance. Eliminating some communication between Earth and the satellite 200 decreases time delay and helps improve performance. The satellite 200 may notify the user terminals 120, 125 of status of the satellite 200 and the content provider 130. The satellite 200 may transmit a “request acknowledgement” or a “request denial” message to the user terminals 120, 125 in response to an access request. Intercepting access request messages also allows the satellite 200 to be informed of current network usage conditions. The satellite 200 may help manage communications resources with minimal additional complexity.

Certain embodiments of the present invention are applicable to other protocols, such as FDMA, TDMA, CDMA, or a hybrid protocol, as well. By shifting acknowledgement and/or other low-overhead functions to the satellite 200, transmission efficiency may be improved.

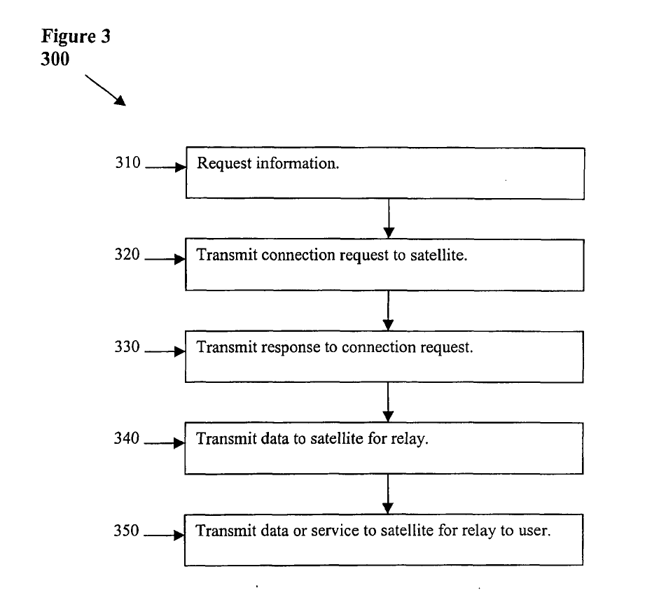

FIG. 3 illustrates a flow diagram for a method 300 for improved satellite data transmission used in accordance with a preferred embodiment of the present invention. First, at step 310, a user requests information or service at the user terminal 120, 125 (such as a web page, a cellular phone call, or an audiovisual program). For example, a person types a web address or uniform resource locator (URL) in a web browser on a personal computer. Next, at step 320, the user terminal 120, 125 transmits a connection request to the satellite 110, 200. For example, a modem or other communication device connected to the personal computer transmits the web page access request to a web server.

Then, at step 330, the satellite 110, 200 transmits a response, such as an acknowledgement or denial message, to the user terminal 120, 125 based on criteria such as available bandwidth and/or connection resources. For example, the satellite 110, 200 sends an acknowledgement message to the personal computer and web browser informing the browser that the web page may be retrieved. The satellite 110, 200 may utilize an allocation or arbitration protocol, such as DAMA or CSMA/CD, to determine availability of and allocation of transmission resources. For example, the satellite 110, 200 may allocate communication channels between several web browsers attempting to retrieve web pages from a web server via the satellite 110, 200.

At step 340, when a connection is available, the user terminal 120, 125 transmits data to the satellite 110, 200 for relay to the content provider 130. For example, the web browser requests a web page from a web server via the satellite 110, 200. Then, at step 350, the content provider 130 transmits a response (data or service, for example) to the satellite 110, 200 for transmission to the user terminal 120, 125. The method 300 may also be used for other applications, such as cellular phone communications and/or audiovisual multicasting to a plurality of users.

As another example, a person enters a phone number into a cellular phone to make a phone call. By dialing a phone number, the user requests a connection from the satellite 110, 200. Then, the satellite 110, 200 sends an acknowledgement message to the cellular phone informing the phone that a call may be placed. The satellite 110, 200 may allocate communication channels between several cellular phones attempting to place calls via the satellite 110, 200. Next, the user places a call via the cellular phone to a base station via the satellite. The base station and satellite relay a response signal from a second cellular phone back to the first cellular phone.

Thus, certain embodiments of the present invention provide a satellite with a hybrid payload. That is, certain embodiments provide a satellite that is partially a bent pipe or transponding satellite and partially a processing satellite. Minimal processing capability may be added to a satellite to reduce transmission latency and facilitate more efficient resource sharing. Certain embodiments of the present invention provide a method for minimizing communication delay and improving operation of a satellite network.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An improved satellite communication system, said system comprising:
a user terminal transmitting a request for communication with a content provider;
a content provider providing at least one of data and service; and
a satellite for relaying transmissions between the user terminal and the content provider, wherein the satellite intercepts the request from the user terminal, wherein the satellite communicates a status to the user terminal.

2. The system of claim 1, wherein the data includes computer-related data.

3. The system of claim 1, wherein the service includes at least one of cellular phone service and audiovisual multicasting service.

4. The system of claim 1, wherein the satellite comprises a hybrid payload satellite using a demand assigned multiple access resource arbitration protocol.

5. The system of claim 1, wherein the satellite includes an acknowledgement processor for intercepting a connection request from the user terminal.

6. The system of claim 5, wherein the acknowledgement processor assigns the user terminal to a communication channel based on criteria.

7. The system of claim 6, wherein the criteria comprises at least one of available bandwidth and number of connection requests.

8. The system of claim 1, further comprising a plurality of user terminals.

9. The system of claim 8, wherein the plurality of user terminals arbitrate collisions of communication requests.

10. A method for facilitating data transmission in a satellite network, said method comprising:
transmitting a communication request for communicating with a content provider;
intercepting the communication request at a satellite; and
returning a status message in response to the communication request.

11. The method of claim 10, wherein the status message comprises an acknowledgement or denial message.

12. The method of claim 10, wherein the status message comprises at least one of satellite and content provider status.

13. The method of claim 10, further comprising transmitting data to the satellite for relay to the content provider.

14. The method of claim 10, further comprising transmitting a response to the satellite for relay to a user terminal.

15. The method of claim 10, further comprising arbitrating a collision between multiple communication requests.

16. The method of claim 10, further comprising assigning the communication request to a communication channel based on criteria.

17. The method of claim 16, wherein the criteria includes at least one of available bandwidth and number of connection requests.

18. A data communication satellite with a hybrid payload, said satellite comprising:
a hybrid communication payload providing signal transmission and minimal processing of the signal;
an antenna for at least one of transmitting and receiving the signal; and
a processor for intercepting a communication request, wherein the processor generates a response to the communication request.

19. The satellite of claim 18, wherein the payload provides minimal processing of the signal.

20. The satellite of claim 18, wherein the communication request is generated by a user terminal.

21. The satellite of claim 18, wherein the payload facilitates communication between a user terminal and a content provider.

22. The satellite of claim 18, wherein the payload uses a demand assigned multiple access resource arbitration protocol.

23. The satellite of claim 18, wherein the processor assigns the communication request to a communication channel based on criteria.

24. The system of claim 23, wherein the criteria comprises at least one of available bandwidth and number of connection requests.
